(19) United States
(12) Patent Application Publication
(10) Pub. No.: US 2011/0235657 A1
(43) Pub. Date: Sep. 29, 2011

(54) Multimode Apparatus and Method

(75) Inventors: Joon Bae KIM, Lexington, MA (US); Vladimir OKSMAN, Morganville, NJ (US)

(73) Assignee: LANTIQ DEUTSCHLAND GmbH, Neubiberg (DE)

(21) Appl. No.: 13/069,515

(22) Filed: Mar. 23, 2011

Related U.S. Application Data
(60) Provisional application No. 61/316,812, filed on Mar. 23, 2010.

(51) Int. Cl. H04J 3/06

(52) U.S. Cl. 370/503

(57) ABSTRACT

A method and apparatus are herein provided to align media access control (MAC) cycles of networks of different medium types. Information is obtained that indicates a timing information of a first MAC cycle in a first network of a first medium type and a second MAC cycle in a second network of a second medium type. A buffer is provided for storing the timing information. Alignment information is derived based on the timing information of the first/second network that enables alignment of the MAC cycles between the first and second networks. A controller unit is provided for deriving the alignment information.

This application claims priority to previously filed Provisional Application No. 61/316,812, filed on Mar. 23, 2010, and entitled TIME-DIVISION MULTIPLEXED MULTIMODE DEVICE. The entire contents of the provisional application are incorporated herewith by reference.

### BACKGROUND

Many conventional point-to-multipoint communication systems use packet-based transmission to provide a communication link between multiple nodes over a shared medium. In such systems it is common that multiple nodes form a network that is controlled by a single master node. The master node controls the medium access of all other nodes in the network by allocating timeslots on a periodic basis. Examples of such systems include IEEE 802.11 (WLAN), IEEE 802.16 (WiMAX), and ITU-T G.9960/G.9961 (G.hn/hnem), Homeplug, IEEE1901, GPON, or MOCA.

In particular, ITU-T G.hn allows a device with one transceiver to operate on multiple medium types by providing a single unified PHY and MAC. The device can operate on multiple medium types simultaneously with small additional hardware. This invention provides methods to synchronize the medium access of the nodes belonging to different networks so that one transceiver can operate as multiple nodes in more than one network.

For a given frequency region in a medium type, a single network is formed and controlled by a single master node. Different networks can be formed over different frequency regions in the same medium type, or can be formed over the same or different frequency regions in different medium types. A single master node controls the medium access of all other nodes in the network by splitting time into cycles (Media Access Control, MAC cycle). The master node may split a cycle further into smaller timeslots for refined medium access of its member nodes. The master node issues the medium access plan (MAP) that describes timeslot allocation for one or more MAC cycles.

In conventional methods, a multimode device operating in different networks is usually composed of multiple transceivers, each of which operates in a single network. One exemplary case is shown in FIG. 1, where one video server (VS) is connected to both power line and coax, and one TV is connected to VS via power line, and another TV is connected to VS via coax. Here VS has two separate transceivers (node P1 and node C1) connecting to two different medium types (power line and coax) that belong to two separate networks (network P and network C). The transceivers are bonded in the sense that they are operated in relation to one another to connect different medium types to the same virtual destination. This implementation enables two networks to operate asynchronously without affecting each other. There is no need to synchronize the medium access of these nodes. However, this conventional solution is hardware intensive as it requires multiple transceivers.

Another conventional method attempts to bridge the divide of the different networks using a master node. In that solution, a multimode device operating in different networks often acts as the master node that controls the medium access of all involved networks. The focus is on the medium access of all nodes in one network vs. the medium access of all nodes in other networks rather than the medium access of an individual node that is a part of the multimode device. On the other hand, this conventional solution leads to the introduction of a multiple of master nodes in the system.

Another solution conventionally provided is to operate the multimode devices such that they do not interfere with each other. There, the multimode device is often the device operating on the same medium type; for example, a multimode device operating on different frequency bands of the same medium type. In that case, however, bandwidth is diminished because the spectrum is typically segmented in round-robin fashion without regard to actual use of the bandwidth. Thus, many transmission segments may go unused, thereby wasting bandwidth.

The above conventional solutions suffer from a number of setbacks. In most cases, a node that belongs to one network is not always active for the entire duration of the MAC cycle because a normal network supports more than one node and the resource (timeslots) of a single network is shared by all nodes, and is usually much more than a single node needs. In this case the multimode device with two bonded transceivers is significantly under-utilized. In other cases a multimode device does not need to be the master node. For example, the set top box (STB) acting as a video server (VS) may not serve as a gateway, which is a common choice for the master node.

FIG. 2 shows an alternate approach where one transceiver serves as two nodes operating in two different networks. If the medium access of this transceiver is synchronized between two networks, one transceiver can communicate with other transceivers in one network at one time instance and the same transceiver can communicate with other transceivers in another network at a different time instance. While the alternate approach saves on hardware, the different networks can still not communicate with each other because no manner in which the various signalling protocols amongst the different networks have been made to be compatible with each other.

In consideration of the above shortcomings of the conventional and alternative solutions, the present invention resolves to provide a multimode device that allows different networks to communicate to each other.

### SUMMARY OF THE INVENTION

A method and apparatus are herein provided to align media access control (MAC) cycles of networks of different medium types. Information is obtained that indicates a timing information of a first MAC cycle in a first network of a first medium type and a second MAC cycle in a second network of a second medium type. A buffer is provided for storing the timing information. Alignment information is derived based on the timing information of the first/second network that enables alignment of the MAC cycles between the first and second networks. A controller unit is provided for deriving the alignment information.

Further according to the invention, there is provided conveying the alignment information to a node of the first/second network.

Further according to the invention, there is provided allocating a compatible medium access period for nodes in the first and second networks.

Further according to the invention, there is provided aligning the first and second MAC cycles.

Further according to the invention, there is provided receiving receives the timing information from the first and second media types from different media types selected from the group consisting of twisted pair, wireless, optical, coaxial and powerline.

Further according to the invention, there is provided changing the length of the first/second MAC cycle to be correspond to the second/first MAC cycle.

Further according to the invention, there is provided setting the length of the first and second MAC cycles different with the criteria that the first/second MAC cycle is an integer multiple of that of the second/first network such that a constant offset among all MAC cycles is maintained.

Further according to the invention, there is provided sending a management packet to a master node containing the timing information for the first/second MAC cycle.

Further according to the invention, there is provided aligning both active and inactive periods of the first and second MAC cycles.

Further according to the invention, there is provided requesting a master node of each of the first and second networks to define one or more medium access periods for a respective MAC cycle.

Further according to the invention, there is provided setting an active medium access period of the first/second MAC cycle of the first/second network to coincide with an inactive medium access period of another network such that a transceiver operating in the first/second network does not receive any packets from other networks.

### BRIEF DESCRIPTION OF THE DRAWINGS

FIG. 1 shows a conventional solution;

FIG. 2 shows an alternative solution;

FIG. 3 shows a flow diagram according to the present invention;

FIGS. 4a and 4b show signal diagrams according to the present invention;

FIG. 5a shows an apparatus that may embody the present invention; and

FIG. 5b shows a transceiver apparatus of the present invention.

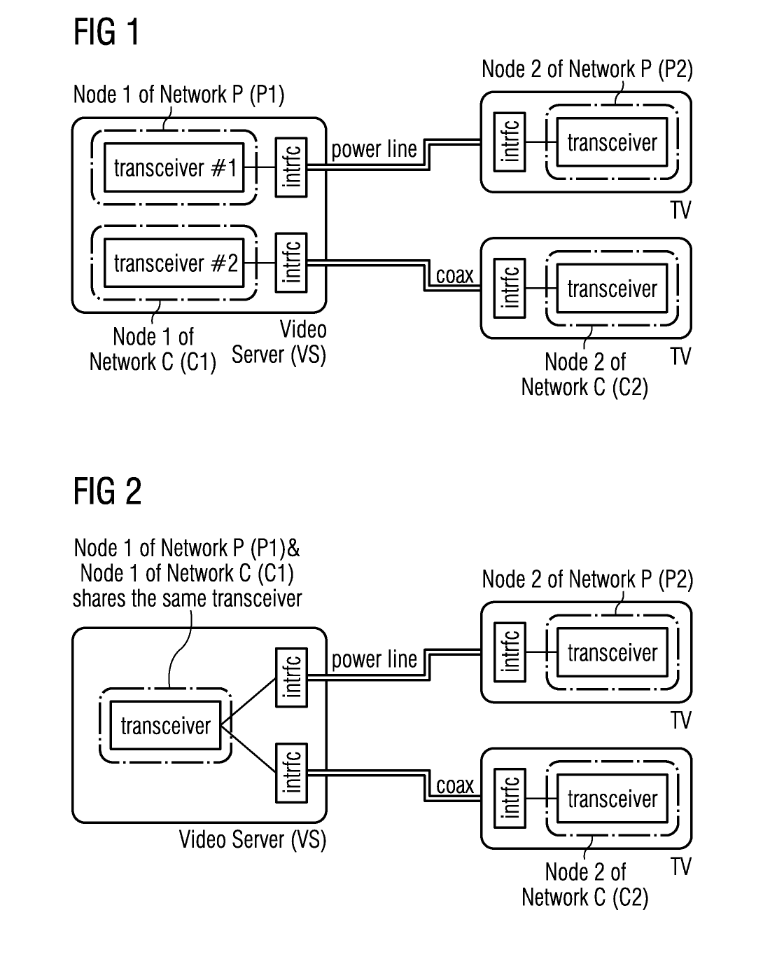

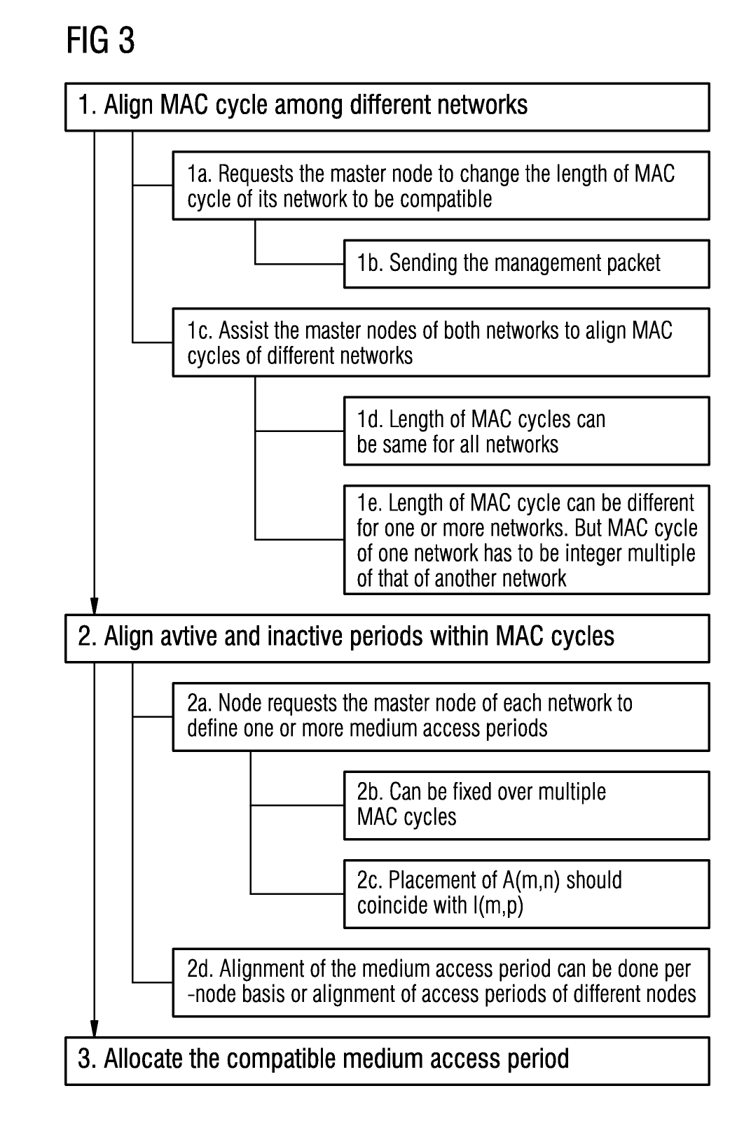

### DETAILED DESCRIPTION

A node is considered active if it is ready to receive packets from other nodes in the network. A node is considered inactive if it is not active. Inactive nodes usually do not transmit, but they may in some occasions. A node cannot transmit to the other node(s) in the network if the node(s) are in inactive period. The time duration during which a node m is active in a network n is referred to as the active period, and denoted as Aₖ(m,n). The time duration during which a node m is inactive in a network n is referred to as the inactive period, and denoted as Iₖ(m,n). One active period followed by one inactive period, or one inactive period followed by one active period, is referred to as the medium access period, and denoted as Tₖ(m,n). The index k denotes these periods defined over different times. The MAC cycle of network n is denoted as M(n). In each MAC cycle, a node can have zero, one, or more medium access periods.

ITU-T G.hn defines the generic structure for a node in the network to request the master node for a specific medium access period for itself (§8.3.6 “Scheduled inactivity”, Editor for G.hn, “Draft G.9961 (for consent),” ITU-T SG15 T09-SG15-100531-TD-WP1-0309, Geneva, Switzerland, January 2010) or for the percents of the activity and inactivity periods rather than a specific location of these periods. However, it does not specify how to coordinate the medium access period of nodes from different networks so that active periods defined in one network are defined as inactive periods in other networks for nodes belonging to a single multimode device.

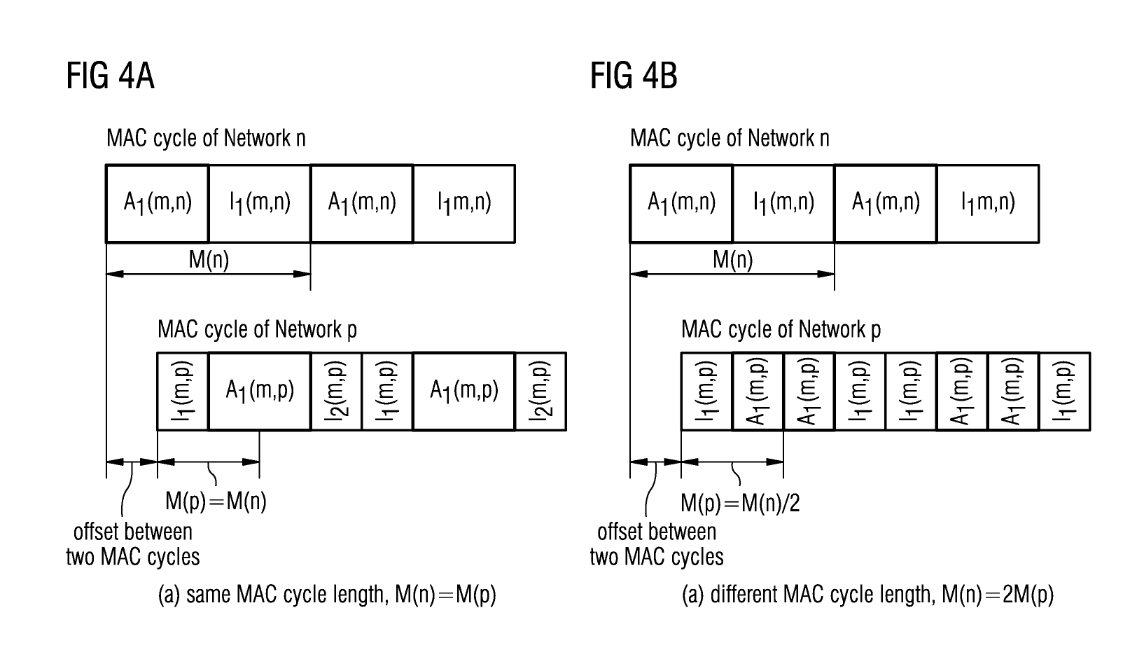

A solution to the foregoing described problem is set forth here in terms of the method steps illustrated in the flow diagram of FIG. 3. One or more of the substeps may be implemented and are below described as solutions of the main steps or alternative substeps.

In a step 1, the MAC cycle is aligned among different networks that a multimode device operates in. In a substep 1.aa node requests the master node to change the length of MAC cycle of its network to be compatible with the MAC cycle of the other network its device is connected. In a substep 1.b this is optionally done by sending the management packet to the master node, or other communication means defined between a node and the master node. In a substep 1.c the multimode device, thus, can assist the master nodes of both networks to align MAC cycles of different networks by sending the similar requests to their master nodes. In a substep 1d, the length of MAC cycles is set the same for all networks. That is, M(n)=M(p) where n≠p. The start time of MAC cycle does not need to be aligned. In a substep 1e the length of MAC cycle can be different for one or more networks. However, the MAC cycle of one network should be an integer multiple of that of another network in order to maintain constant offset among all MAC cycles. That is, M(n)=jM(p) where n≠p and j=1, 2, . . . etc.

Proceeding now to step 2, the active and inactive periods are aligned within MAC cycles defined among different networks. In a substep 2a, after MAC cycles of different networks are aligned, a node requests the master node of each network to define one or more medium access periods for its MAC cycle. In a substep 2b, allocation of the medium access period is fixed over multiple MAC cycles. That is, the same medium access period repeats MAC cycle after MAC cycle. In substep 2c, the placement of A(m,n) is preferably set to coincide with I(m,p) so that while one transceiver (node m) operates in one network (n), it does not get any packet from any nodes from other networks (p≠n) during that time. In a substep 2d, alignment of the medium access period is done per-node basis. However, if necessary, alignment of access periods of different nodes in the network should be possible.

In step 3, where a multimode device serves as the master node in both networks. It can now allocate the compatible medium access period for all of its member nodes.

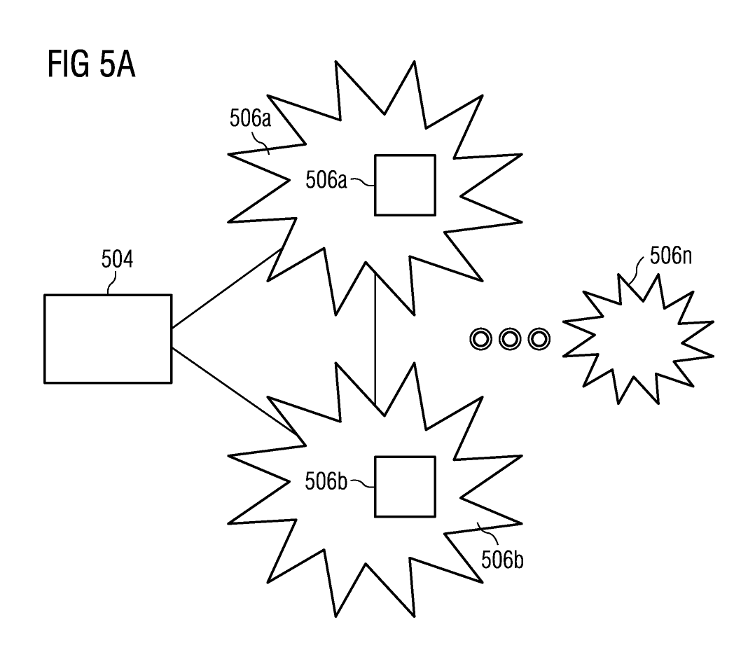

FIGS. 4a and b illustrate two examples of the medium access period alignment for a multimode device having two nodes (m) operating in two networks (n, p): In case (a) the lengths of MAC cycles of two networks are the same. In another case (b) the length of one is twice as large as the other. In both cases (a) and (b) the MAC cycles between different networks—owing to the solution proposed herein—are shown to be aligned.

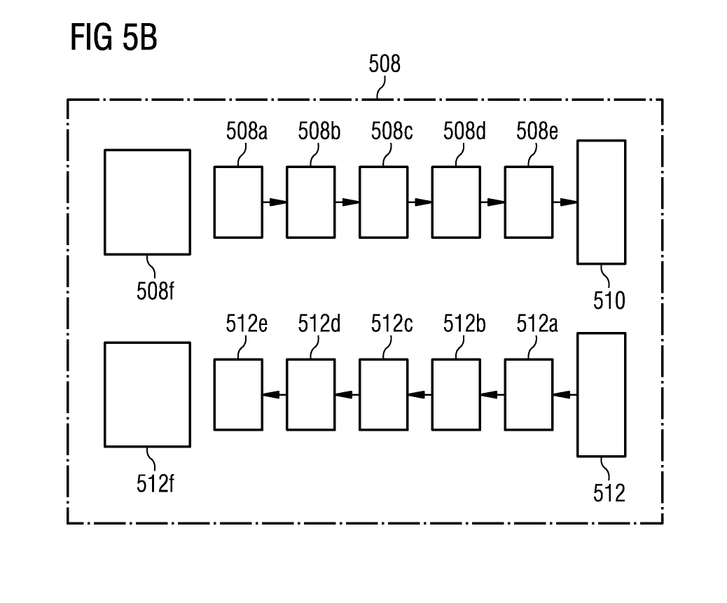

An exemplary communication arrangement 500 is shown in FIG. 5a to employ at least two multicarrier apparatuses or nodes 502a, b. The exemplary communication arrangement may also employ a multicarrier controller apparatus or controller node (504). In one implementation, the multicarrier apparatuses/controller 504 are Orthogonal Frequency Division Multiplexing (OFDM) apparatuses capable of implementing the herein described implementations.

The multicarrier apparatuses 502a, b may communicate through one or more different types of communication channels (or networks) 506a . . . n. The communication channel 506a . . . n may be realized as a wireless communication medium, a wireline communication medium (e.g., coaxial cable, twisted pair of copper wires, power line wiring, optical fiber, etc.), or combinations thereof. Accordingly, the multicarrier apparatuses 502a, b, may include structure and functionality that enable signal communication over such medium. Such structure and functionality may include one or more antennas, integrated wireline interfaces, and the like. Depending on the implementation, the multicarrier apparatuses may communicate with one another directly (peer-to-peer mode) or the multicarrier apparatuses may communicate via the controller apparatus.

In one implementation, the exemplary communication arrangement may be a home network and the multicarrier controller apparatus may be an access point of the home network. For example, in the implementation the controller apparatus may be a residential gateway that distributes broadband services to the multicarrier apparatuses 502a, b. The multicarrier apparatuses 502a, b may be associated with digital content destinations in the home, but may also be associated with digital content sources, such as digital video recorders (DVR), computers providing streaming video, televisions, entertainment centers, and the like.

Furthermore, the multicarrier apparatuses 502a, b may be enabled to communicate using packet-based technology (e.g., ITU G.hn, HomePNA, HomePlug® AV and Multimedia over Coax Alliance (MoCA)) and xDSL technology. Such xDSL technology may include Asymmetric Digital Subscriber Line (ADSL), ADSL2, ADSL2+, Very high speed DSL (VDSL), VDSL2, G.Lite, and High bit rate Digital Subscriber Line (HDSL). In addition, the multicarrier apparatuses 502a, b may be enabled to communicate using IEEE 802.11 and IEEE 802.16 (WiMAX) wireless technologies.

Signals exchanged between the multicarrier apparatuses may 502a, b include multicarrier symbols that each include a plurality of tones or sub-channels. Each of the tones within a multicarrier symbol may have data bits modulated thereon that are intended for delivery from one of the multicarrier apparatuses 502a, b to another.

An exemplary transceiver apparatus 508 is shown in FIG. 5b that may be used as a transmitting and receiving apparatus in a multicarrier arrangement or system is described in the following. The multicarrier/apparatuses controller 504 in one embodiment may include the transceiver. As an another alternative, the multicarrier apparatuses 502a, b may be implemented in the same or similar manner as the exemplary transceiver apparatus.

The transceiver apparatus 508 may include a transmitter 510 that incorporates a number of different elements. For example, the transmitter or transceiver apparatus may include any of the following, including a buffer 508a, an encoder 508b, a modulator 508c, a filter 508d, an interface 508e and a controller 508f. As used herein, the term “controller” is meant generally to include all types of digital processing devices including, without limitation, digital signal processors (DSPs), reduced instruction set computers (RISC), general-purpose (CISC) processors, microprocessors, gate arrays (e.g., FPGAs), PLDs, reconfigurable compute fabrics (RCFs), array processors, secure microprocessors, and application-specific integrated circuits (ASICs). Such digital processors may be contained on a single unitary IC die, or distributed across multiple components.

The encoder 510b may be capable of receiving data that is for communication to a receiving device coupled to the transceiver apparatus via a wireless or wireline medium. More specifically, the encoder may be capable of translating incoming data bit streams into in-phase and quadrature components for each of the plurality of tones. The encoder 510b may be arranged to output a number of symbol sequences that are equal to the number of tones available to the system. The modulator may be capable of receiving symbol sequences to produce a modulated signal in the form of a discrete multi-tone signal. The modulator may pass the modulated signal to the filter to undergo various filtering and then the filtered signal may be passed to the interface for communication over the medium to a receiving device.

The transceiver apparatus 508 may also include a receiver 512 that is capable of receiving modulated multi-tone signals communicated over the medium from a transmitting device. The receiver or transceiver device may include any of the following including an interface 512a, a filter 512b, a demodulator 512c, a decoder 512d and a controller 512e. Alternatively, the transceiver apparatus may implement a single controller, instead of the illustrated controllers and. Signals received by the receiver 512 may be passed to the filter via the interface 512a. After received signals undergo filtering by way of the filter 512b, the filtered signals may be demodulated by the demodulator 512c. The demodulated signals may be passed to and processed by the decoder 512d. The decoder 512d produces data bit streams for consumption by a computing device, or the like. Effectively, the demodulator and the decoder perform the opposite functions of the modulator and the encoder, respectively.

Exemplary implementations discussed herein may have various components collocated; however, it is to be appreciated that the various components of the arrangement may be located at distant portions of a distributed network, such as a communications network and/or the Internet, or within a dedicated secure, unsecured and/or encrypted arrangement. Thus, it should be appreciated that the components of the arrangements may be combined into one or more apparatuses, such as a modem, or collocated on a particular node of a distributed network, such as a telecommunications network. Moreover, it should be understood that the components of the described arrangements may be arranged at any location within a distributed network without affecting the operation of the arrangements. For example, the various components can be located in a Central Office modem (CO, ATU-C, VTU-O), a Customer Premises modem (CPE, ATU-R, VTU-R), an xDSL management device, or some combination thereof. Similarly, one or more functional portions of the arrangement may be distributed between a modem and an associated computing device.

The above-described arrangements, apparatuses and methods may be implemented in a software module, a software and/or hardware testing module, a telecommunications test device, a DSL modem, an ADSL modem, an xDSL modem, a VDSL modem, a linecard, a G.hn transceiver, a MOCA transceiver, a Homeplug transceiver, a powerline modem, a wired or wireless modem, test equipment, a multicarrier transceiver, a wired and/or wireless wide/local area network system, a satellite communication system, network-based communication systems, such as an IP, Ethernet or ATM system, a modem equipped with diagnostic capabilities, or the like, or on a separate programmed general purpose computer having a communications device or in conjunction with any of the following communications protocols: CDSL, ADSL2, ADSL2+, VDSL1, VDSL2, HDSL, DSL Lite, IDSL, RADSL, SDSL, UDSL, MOCA, G.hn, Homeplug or the like.

Additionally, the arrangements, procedures and protocols of the described implementations may be implemented on a special purpose computer, a programmed microprocessor or microcontroller and peripheral integrated circuit element(s), an ASIC or other integrated circuit, a digital signal processor, a flashable device, a hard-wired electronic or logic circuit such as discrete element circuit, a programmable logic device such as PLD, PLA, FPGA, PAL, a modem, a transmitter/receiver, any comparable device, or the like. In general, any apparatus capable of implementing a state machine that is in turn capable of implementing the methodology described and illustrated herein may be used to implement the various communication methods, protocols and techniques according to the implementations.

Furthermore, the disclosed procedures may be readily implemented in software using object or object-oriented software development environments that provide portable source code that can be used on a variety of computer or workstation platforms. Alternatively, the disclosed arrangements may be implemented partially or fully in hardware using standard logic circuits or VLSI design. The communication arrangements, procedures and protocols described and illustrated herein may be readily implemented in hardware and/or software using any known or later developed systems or structures, devices and/or software by those of ordinary skill in the applicable art from the functional description provided herein and with a general basic knowledge of the computer and telecommunications arts.

Moreover, the disclosed procedures may be readily implemented in software that can be stored on a computer-readable storage medium, executed on programmed general-purpose computer with the cooperation of a controller and memory, a special purpose computer, a microprocessor, or the like. In these instances, the arrangements and procedures of the described implementations may be implemented as program embedded on personal computer such as an applet, JAVA® or CGI script, as a resource residing on a server or computer workstation, as a routine embedded in a dedicated communication arrangement or arrangement component, or the like. The arrangements may also be implemented by physically incorporating the arrangements and/or procedures into a software and/or hardware system, such as the hardware and software systems of a test/modeling device.

The implementations herein are described in terms of exemplary embodiments. However, it should be appreciated that individual aspects of the implantations may be separately claimed and one or more of the features of the various embodiments may be combined.

1. A method to align media access control (MAC) cycles of networks of different medium types, comprising:
obtaining information indicating timing information of a first MAC cycle in a first network of a first medium type and a second MAC cycle in a second network of a second medium type; and
deriving alignment information based on the timing information of the first/second network that enables alignment of the MAC cycles between the first and second networks.

2. The method according to claim 1, further comprising the step conveying the alignment information to a node of the first/second network.

3. The method according to claim 1, further comprising the step of allocating a compatible medium access period for nodes in the first and second networks.

4. The method according to claim 1, further comprising the step of aligning the first and second MAC cycles.

5. The method according to claim 1, wherein the step of receiving receives the timing information from the first and second media types from different media types selected from the group consisting of twisted pair, wireless, optical, coaxial and powerline.

6. The method of claim 1, further comprising the step of changing the length of the first/second MAC cycle to be correspond to the second/first MAC cycle.

7. The method of claim 1, further comprising the step of setting the length of the first and second MAC cycles different with the criteria that the first/second MAC cycle is an integer multiple of that of the second/first network such that a constant offset among all MAC cycles is maintained.

8. The method of claim 1, further comprising the step of sending a management packet to a master node containing the timing information for the first/second MAC cycle.

9. The method according to claim 1, further comprising the step of aligning both active and inactive periods of the first and second MAC cycles.

10. The method according to claim 1, further comprising the step of requesting a master node of each of the first and second networks to define one or more medium access periods for a respective MAC cycle.

11. The method of claim 1, further comprising the step of setting an active medium access period of the first/second MAC cycle of the first/second network to coincide with an inactive medium access period of another network such that a transceiver operating in the first/second network does not receive any packets from other networks.

12. An apparatus to align media access control (MAC) cycles of networks of different medium types, comprising:
a buffer that receives information indicating a timing information of a first MAC cycle in a first network of a first medium type and a second MAC cycle in a second network of a second medium type; and
a controller that derives, based on the timing information, an alignment information of the first/second network that enables alignment of the MAC cycles between the first and second networks.

13. The apparatus according to claim 12, further comprising a transmitting unit that conveys the alignment information to a node of the first/second network.

14. The apparatus according to claim 12, wherein the controller allocates a compatible medium access period for nodes in the first and second networks.

15. The apparatus according to claim 12, wherein the controller aligns the first and second MAC cycles.

16. The apparatus according to claim 12, wherein the step of receiving receives the timing information from the first and second media types from different media types selected from the group consisting of twisted pair, wireless, optical, coaxial and powerline.

17. The apparatus of claim 12, wherein the controller changes the length of the first/second MAC cycle to be correspond to the second/first MAC cycle.

18. The apparatus of claim 12, wherein the controller sets the length of the first and second MAC cycles different with the criteria that the first/second MAC cycle is an integer multiple of that of the second/first network such that a constant offset among all MAC cycles is maintained.

19. The apparatus of claim 12, further comprising a node that sends a management packet to a master node containing the timing information for the first/second MAC cycle.

20. The apparatus according to claim 12, wherein the controller aligns both active and inactive periods of the first and second MAC cycles.

21. The apparatus of claim 12, wherein the controller sets an active medium access period of the first/second MAC cycle of the first/second network to coincide with an inactive medium access period of another network such that a transceiver operating in the first/second network does not receive any packets from other networks.
